(19) United States
(12) Patent Application Publication
(10) Pub. No.: US 2004/0210832 A1
(43) Pub. Date: Oct. 21, 2004

(54) Character string edition apparatus and program

(76) Inventors: Kazuhiko Iwanaga, Aichi-ken (JP); Tatsuhiro Ikedo, Gifu-ken (JP); Chitoshi Ito, Aichi-ken (JP)

Correspondence Address: Oliff & Berridge, PO Box 19928, Alexandria, VA, 22320, US

(21) Appl. No.: 10/487,256

(22) PCT Filed: Aug. 26, 2002
(86) PCT No.: PCT/JP02/08550

(30) Foreign Application Priority Data
Aug. 31, 2001 (JP) 2001-264810

(51) Int. Cl. G06F 15/00

(52) U.S. Cl. 715/505

(57) ABSTRACT

It is judged whether or not a process mode is in the tape-width-obtaining-mode. If it is in the tape-width-obtaining-mode, the tape width of the tape cassette installed in the printing device is obtained. Based on the obtained tape width, the width of the tape image is changed into the width corresponding to the obtained tape width, and the tape width is displayed in the tape size display area. Thereby, it is possible to edit the text while grasping the paper size and the like of the paper loaded in the printing device.

### TECHNICAL FIELD

The present invention relates to a text editing apparatus for editing text to be formed on an image forming medium and to a program for controlling the text editing apparatus.

### BACKGROUND ART

When a user edits text (including layout) by an editor installed in a personal computer and prints the edited text by a printing device, the user sets a printing paper size and the like before printing by the printing device. After setting, the edited text is printed by the printing device. The personal computer has not obtained the size of the paper loaded in the printing device before this printing time. If the obtained paper size does not include the paper size set by the user, the personal computer displays an alert on a display which indicates that the paper of the size set by the user is not loaded in the printing device.

### DISCLOSURE OF THE INVENTION

According to the above-described procedure, when editing text, because the user does not know the size of the paper loaded in the printing device the text might be edited in accordance with the size of the paper not loaded in the printing device. In such a case, it is necessary for the user to re-edit the text in accordance with the size of the paper loaded in the printing device, which might not be convenient for the user.

It is therefore an object of the present invention to provide a text editing apparatus and a text editing program in which a user can edit text, while grasping the paper size and the like loaded in a printing device.

A text editing apparatus of the present invention is for editing a text to be formed on an image forming medium, and comprises medium information obtaining means for obtaining intermittently information related to the image forming medium to be used, and display controlling means for controlling to display the information related to the printing medium obtained by the medium information means, on a display. A program for editing text to be formed on an image forming medium causes a computer to function as the text editing apparatus.

According to the present invention, the information related to the image forming medium on which a text will be formed is displayed on the display, so that the user can grasp the information related to the image forming medium on which a text will be formed and can edit the text while knowing the information, which is more convenient for the user when editing the text.

### BRIEF DESCRIPTION OF THE DRAWINGS

FIG. 1 is a perspective view of a personal computer functioning as a text editing apparatus and of a printing device.

FIG. 2 is a plan view of a print mechanism and a tape containing cassette arranged inside of the printing device shown in FIG. 1.

FIG. 3 is a block diagram illustrating a control system of the computer.

FIG. 4 is a block diagram illustrating the function of the CPU in the computer the control system of which is shown in FIG. 3.

FIGS. 5A to 5B are examples of an editor screen displayed on a liquid crystal display of the personal computer shown in FIG. 1.

FIG. 6 is a flowchart showing a train of processes in the mode-setting module of the CPU shown in FIG. 4.

FIG. 7 is a flowchart showing another process for the mode-setting module of the CPU shown in FIG. 4.

FIG. 8 is a schematic flowchart showing a process for the display-changing module of the CPU shown in FIG. 4.

FIG. 9 is a flowchart showing a process in a tape width obtaining module of the CPU shown in FIG. 4.

### BEST MODE FOR CARRYING OUT THE INVENTION

A preferred embodiment of the present invention will be described with reference to the drawings.

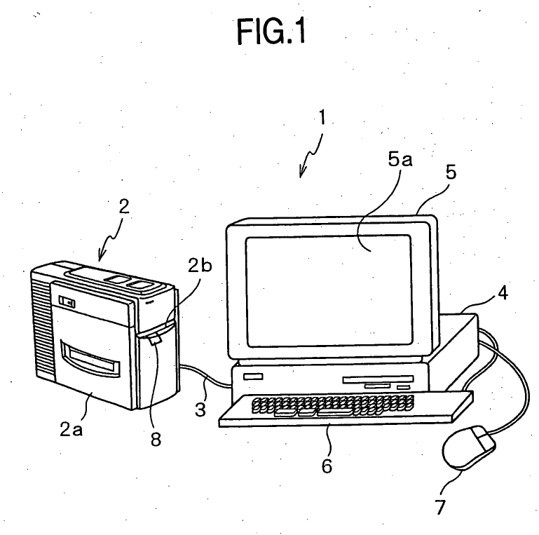

FIG. 1 is a perspective view of a printing device and of a personal computer (hereinafter referred to as computer), which functions as a text editing apparatus in the present embodiment and a printing device. As shown in FIG. 1, the computer 1 and the printing device 2 are connected with a connecting cable 3. Data is communicated between computer 1 and the printing device 2 through the connecting cable 3.

Also, as shown in FIG. 1, the computer 1 includes a main control portion 4, which has a CPU, RAM, and the like inside, a liquid crystal display 5 having a display portion 5a (liquid crystal panel), a keyboard 6 which includes various keys such as character keys, control keys and the like, a mouse 7 for pointing and inputting a specific coordinate. The liquid crystal display 5, the keyboard 6, and the mouse 7 are respectively connected to the main control portion 4 with connecting lines.

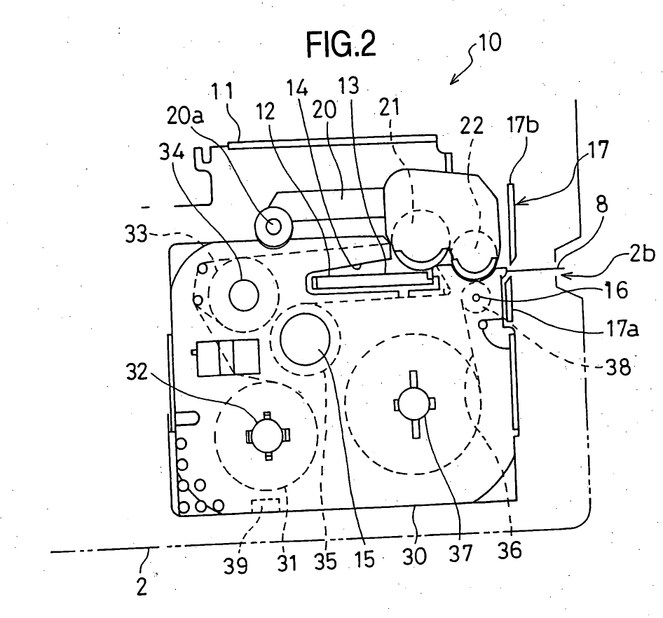

Also, as shown in FIG. 1, the printing device 2 includes a discharging slot 2b for discharging a tape 8 in front of its body 2a. In addition, the printing device 2 includes a removable tape-containing cassette 30 which will be described below and further includes a print mechanism 10 (shown in FIG. 2), a cutter 17 for cutting tape (shown in FIG. 2), and the like. The printed tape 8 fed from the tape-containing cassette 30 will be discharged from the discharging slot 2b after being cut by the cutter 17.

FIG. 2 is a plan view of a print mechanism 10 and tape-containing cassette 30 arranged inside of the printing device 2 shown in FIG. 1. As shown in FIG. 2, the tape-containing cassette 30 is removably loaded in a cassette-containing frame 11 within the printing device 2. Within the tape containing cassette 30, there are respectively rotatably provided a tape spool 32 around which a transparent laminate tape 31 (such as PET) is wound; a ribbon supply spool 34 around which an ink ribbon 33 is wound; a take-up spool 35 for taking up the used ink ribbon 33; a supply spool 37 around which a double-coated tape 36 having the same width as the laminate tape 31 is wound with its peel-off paper on the outside; and a joining roller 38 for adhering the double-coated tape 36 to the laminate tape 31. The double-coated tape 36 includes a base tape, on both sides of which are formed adhesive layers, and a peel-off paper attached to the adhesive layer on one side of the base tape.

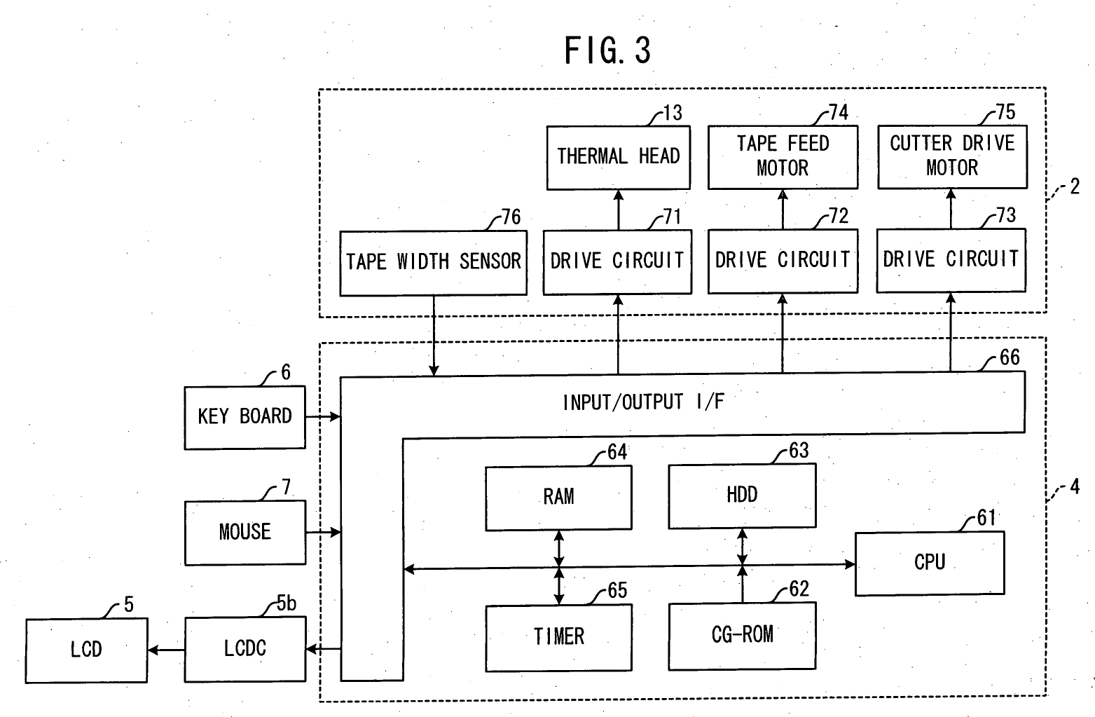

The tape-containing cassette 30 has a projecting piece 39 formed with three projecting claws for identifying the tape width of the tape contained in the tape-containing cassette 30. In addition, the printing device 2 is provided with a tape width sensor 76 (shown in FIG. 3) for detecting the tape width from the condition of the projecting piece 39. The tape widths include sizes such as 6 mm, 9 mm, 12 mm, 18 mm, and 24 mm.

As shown in FIG. 2, in the cassette-containing frame 11, an arm 20 is pivotally supported around a shaft 20a. At the tip of the arm 20, a platen roller 21 and a feed roller 22 both having elastic material such as rubber on the surface are pivotally supported. At the furthest location where the arm 20 moves clockwise, the platen roller 21 presses the laminate tape 31 and the ink ribbon 33 against a thermal head 13 described later, and the feed roller 22 presses the laminate tape 31 and the double-coated tape 36 against the joining roller 38.

A plate 12 extends from the cassette containing frame 11. The thermal head 13 is arranged on the platen roller 21 facing the plate 12, and has heating elements aligned in the vertical direction of FIG. 2. When the tape-containing cassette 30 is loaded in a predetermined location, the plate 12 is inserted in a concave portion 14 of the tape-containing cassette 30. Further, a take-up roller 15 and a joining roller drive roller 16 extend from cassette-containing frame 11. When the tape-containing cassette 30 is loaded in the predetermined location, the take-up roller 15 and the joining roller drive roller 16 are respectively inserted into the take-up spool 35 and into the joining roller 38.

When power is supplied to a tape feed motor 74 (refer to FIG. 3) provided with the printing device 2, the take-up spool 35 through the take-up roller 15, the joining roller 38 through the joining roller driving roller 16, the platen roller 21, and the feed roller 22 rotate. The driving power generated by these rotations carries the laminate tape 31, the ink ribbon 33, and the double coated tape 36 downstream, while being wound off. The laminate tape 31 and the ink ribbon 33 are overlapped with each other and pass between the platen roller 21 and the thermal head 13. While they are fed while being nipped by the platen roller 21 and the thermal head 13, and heating elements arranged on the thermal head 13 are selectively and intermittently supplied with electric current, the ink of the ink ribbon 33 is transferred as dot units onto the laminate film 31 so that a desired dot image is formed as a mirror image. Also, after the ink ribbon 33 that has passed through the thermal head 13 is wound around the take-up roller 15, the laminate tape 31 is overlapped with the double coated tape 36, and passes between the feed roller 22 and the joining roller 38. Thereby, the printed side of the printed laminate tape 31 is firmly overlapped with the double coated tape 36.

On the tape 8 overlappingly comprised with the laminate tape 31 and the double-coated tape 36, an erect image of the print image can be seen from the opposite of the printing side. The printed tape 8 is cut by the cutter 17, which is arranged at the downstream of the feed roller 22, and is discharged from the discharging slot 2b. The cutter 17 is a cutting mechanism, in which a movable blade 17b swings against a stationary blade 17a to cut a cutting object. The movable blade 17b is swung by a cutter drive motor 75 (refer to FIG. 3) and cuts the printed tape 8. The cut tape 8 can be used as an adhesive label capable of being put anywhere by removing the peel-off paper.

The computer 1 functioning as a concrete example of the invention will be described with reference to FIG. 3. FIG. 3 is a functional block diagram to describe the control system of computer 1.

As shown in FIG. 3, a main control portion 4 has a CPU 61 for various controls and operations, a CG-ROM 62, a hard disc 63, a RAM 64, a timer 65, and an input/output interface 66 (hereinafter referred to as I/F).

The I/F 66 in the main control portion 4 is connected to a display controller (LCDC) 5b with a RAM for display to output display data to the liquid crystal display (LCD) 5, a keyboard 6, and a mouse 7. Further, the I/F 66 is connected to a drive circuit 71 for driving the thermal head 13 in the printing device 2, a drive circuit 72 for driving the above-described tape feed motor 74, a drive circuit 73 for driving the above-described cutter drive motor 75, and the above-described tape width sensor 76.

In the CG-ROM 62, a number of character dot pattern data for print and display are stored corresponding to the character code data. Also, stored in the hard disc 63 are an OS (operating system) software based on GUI (Graphical User Interface) and various programs and data tables such as an editor for editing text according to an embodiment of the invention.

The RAM 64 includes an area for storing text data to be displayed input from the keyboard 6, an area for storing the information related to a tape width loaded in a tape contain cassette 30 installed in the printing device 2, a work area for CPU 61 and the like. Also, the timer 65 is a system for generating a signal periodically.

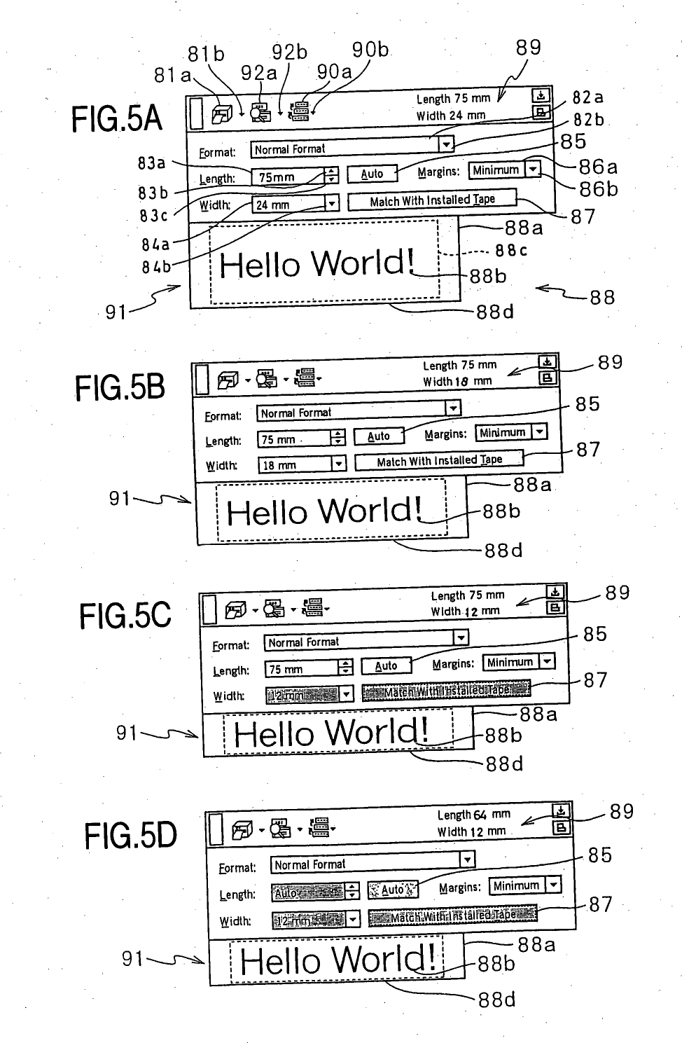

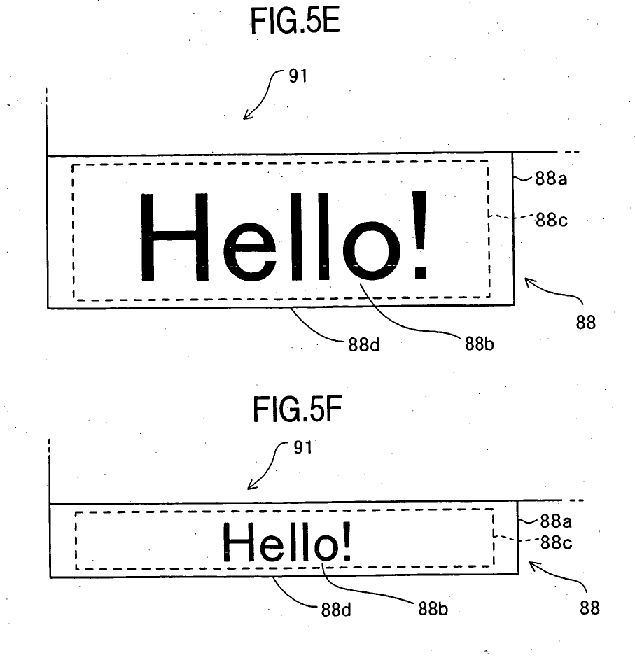

Before describing the process being performed by the CPU 61, in order to understand easily about the process being performed by the CPU 61, an editor screen to be displayed on the display LCD 5 will be described with reference to FIG. 5A through FIG. 5B. The editor screen displays a print button 81a to be selected when outputting edited text to the printing device 2, and a print pull down button 81b for displaying registered print methods as a pull down menu.

Also, the editor screen displays a format display area 82a for displaying on a text display area 88 to be described later and for displaying printing format of the printing device 2, and a format pull down button 82b for displaying pre-registered formats as a pull down menu. A user selects a desired format from the format display area 82a or the pull down menu displayed when the format pull down button 82b is clicked. Then the format the user selected is displayed on the format display area 82b.

The editor screen displays a tape length input area 83a for inputting the tape length of the tape the user desires, a tape length increasing button 83b for increasing the tape length by a predetermined length per each push, and a tape length decreasing button 83c for decreasing the tape length by a predetermined length per each push. However, in a tape length auto setting mode selected with a tape length auto setting button 85 described later by the user, the user cannot input in the tape length inputting area 83a, or activate the tape length increasing button 83b or the tape length decreasing button 83c (refer to FIG. 5D).

The editor screen displays a tape width display area 84a for displaying the tape width the user designated, and a tape width pull down button 84b for displaying pre-registered tape widths (such as 6 mm, 9 mm, 12 mm, 18 mm, 24 mm, 36 mm) as a pull down menu. The user selects a desired tape width from the tape width display area 84a or the pull down menu displayed when the tape width pull down button 84b is clicked. Then the tape width the user selected is displayed on the tape width display area 84a. However, in the tape-width-not-obtaining mode (the user designates the tape width but the tape width of the tape contained in the tape-containing cassette 30 installed in the printing device 2 is not obtained), the user can input the tape width (refer to FIG. 5A and FIG. 5B). On the other hand, in the tape-width-obtaining mode (the tape width of the tape contained in the tape containing cassette 30 installed in the printing device 2 is obtained), the user cannot input the tape width (refer to FIG. 5C and FIG. 5D).

On the editor screen, a tape width length auto setting button 85 is displayed in order to select whether the user designates the tape length of the tape to print the edited text by the user (tape length manual setting mode), or the tape length is automatically set (the tape length is decided based on the longest line of one or plural lines the user input: tape length auto setting mode).

The editor screen displays a margin width display area 86a for displaying the information related to the margin width in feed direction of the tape the user sets, a margin width pull down button 86b for displaying the information related to pre-registered margin width (such as Minimum or Maximum) as a pull down menu. The user selects a desired margin width from the margin width display area 86a or the pull down menu displayed when the margin width pull down button 86b is clicked. Then the information related to the margin width the user selected is displayed on the margin width display area 86a.

On the editor screen, a mode setting button 87 for selecting and inputting either tape-width-obtaining-mode or tape-width-not-obtaining mode is displayed. The user can select either the tape-width-obtaining-mode or the tape-width-not-obtaining-mode by the mode setting button 87 before editing text. Also, the user can switch the mode such as from the tape-width-not-obtaining-mode to the tape-width-obtaining-mode by the mode setting button 87 while and after editing text.

At the lower part of the editor screen there is a text display area 91, which switches to display text view, label view 88, or neither of them by the button 92a or 92b. Here, the label view 88 will be described. In the tape-width-obtaining-mode, an edited text 88b and a dotted line 88c which indicates printing area are displayed on the tape image 88a having the tape width corresponding to the tape width of the tape contained in the tape containing cassette 30 (the latest obtained tape width). In the tape-width-not-obtaining-mode, the edited text 88b is displayed according to the font and point to be actually printed in the form of WYSIWYG (What You See is What You Get) on the tape image 88a having the tape width corresponding to the tape width the user designated and the dotted line 88c which indicates printing area is displayed.

The user can set the tape-width-not-obtaining-mode and switch from the tape-width-obtaining-mode to the tape-width-not-obtaining-mode by dragging the lower part of the label view 88 with the mouse 7. In addition, the user can set the tape width to be printed by regulating a dragging amount of the mouse 7. Further, the user can set the tape-width-obtaining-mode and switch from the tape-width-not-obtaining-mode to the tape-width-obtaining-mode by double-clicking the mouse 7 at the bottom region 88d of the label view 88.

On the right upper area of the editor screen, there is a tape size display area 89 which displays the tape length and the tape width of the printing tape. The tape width displayed in the tape size display area 89 is the width of the tape contained in the tape-containing cassette 30 installed in the printing device 2. On the other hand, in the tape-width-not-obtaining-mode, the tape width the user input is displayed in the tape size display area 89.

Further, on the editor screen, a history button 90a and a history pull down button 90b are displayed. Every time the history button 90a is clicked, the text the user input in the past is displayed on the text display area 88 one by one. When the history pull down button 90b is clicked, plural texts the user input in the past (such as the latest 10 texts) are displayed as a pull down menu.

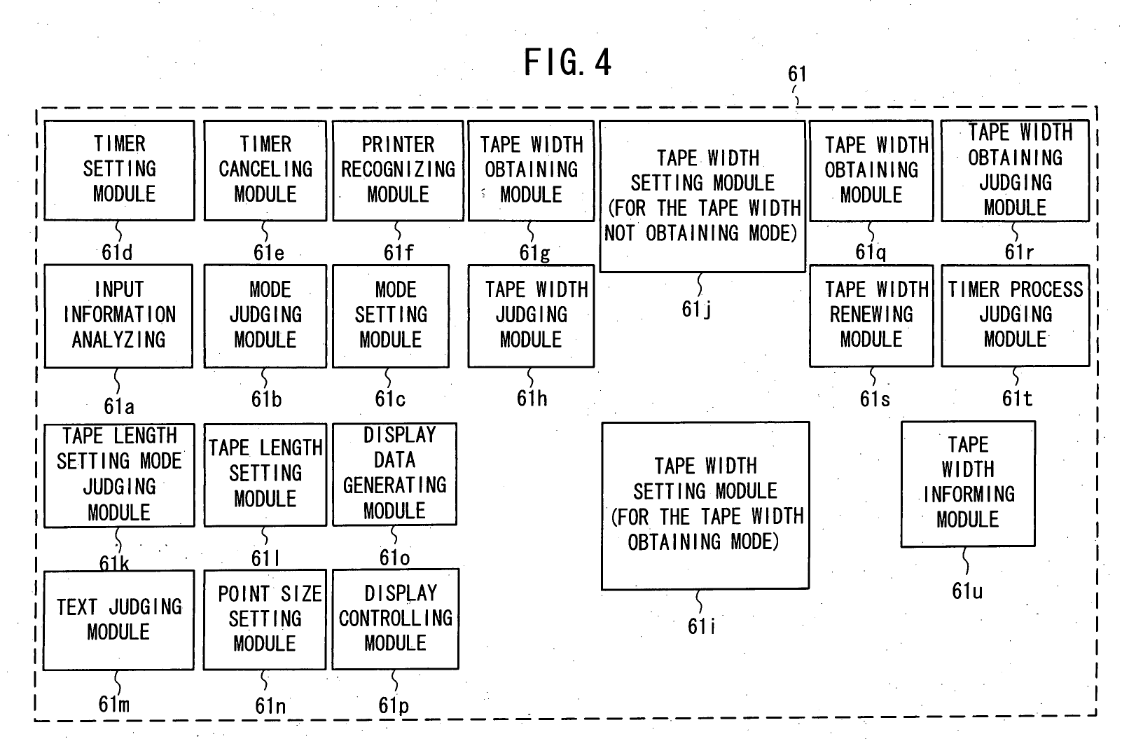

The function of the CPU 61 will be described referring to FIG. 4 as follows. FIG. 4 is a block diagram to describe the function of the CPU 61. The CPU 61 performs the mode setting process, the display changing process, and the tape-width obtaining process.

As shown in FIG. 4, the CPU 61 functions as an input information analyzing module 61a, a mode judging module 61b, a mode setting module 61c, a timer setting module 61d, a timer canceling module 61e, a printer recognizing module 61f, a tape width obtaining module 61g, a tape width judging module 61h, a tape width setting module 61i (for the tape-width-obtaining-mode), a tape width setting module 61j (for the tape-width-not-obtaining-mode), a tape length setting mode judging module 61k, a tape length setting module 61l, a text judging module 61m, a point size setting module 61n, a display data generating module 61o, a display controlling module 61p, a tape width obtaining module 61q, a tape width obtaining judging module 61r, a tape width renewing module 61s, a timer process judging module 61t, and a tape width informing module 61u.

The input information analyzing module 61a analyzes the information input by the user by means of the keyboard 6 or the mouse 7, based on push-signal(s) received through the I/F 66 from the keyboard 6 or coordinate-signal(s) received through the I/F 66 from the mouse 7.

The mode judging module 61b judges whether the mode designated by the user is the tape-width-obtaining-mode or the tape-width-not-obtaining-mode, based on the result analyzed by the input information analyzing module 61a. Namely, the mode judging module 61b judges that the user designated the tape-width-obtaining-mode, in the case that the result analyzed by the input information 61a shows that the mode setting button 87 was pushed by an input operation of the mode setting button 87 by the user (the state of FIG. 5C and FIG. 5D), or that the bottom region 88d of the label view 88 was double-clicked. On the other hand, the mode judging module 61b judges that the user designated the tape-width-not-obtaining-mode, in the case that the result analyzed by the input information 61a shows that the mode setting button 87 was not pushed by an input operation of the mode setting button 87 by the user (the state of FIG. 5A and FIG. 5B), or that the bottom region 88d of the label view 88 was dragged. Therefore, the input information analyzing module 61a and the mode judging module 61b function as a mode setting means and a mode judging means.

The mode setting module 61c sets the process mode to be performed by the CPU 61 to either the tape-width-obtaining-mode or the tape-width-not-obtaining-mode based on the result judged by the mode judging module 61b. The mode setting module 61c switches the mode to be performed by the CPU 61, corresponding to a switching by the user if the user switched the mode. Therefore, the mode setting module 61c also functions as a mode switching means.

The timer setting module 61d sets the timer 65 to generate signals at fixed time intervals (such as one second) when the tape-width-obtaining-mode was set by the mode setting module 61c. The timer canceling module 61e cancels timer 65 when the tape-width-not-obtaining-mode was set by the mode setting module 61c. With this cancellation, the timer 65 stops generating signals at the fixed time intervals.

The printer recognizing module 61f judges whether the computer 1 is connected to a printer, and whether a printer driver for controlling the printing device 2 connected to the computer 1 is installed in the computer 1, that is, whether or not the printing device 2 connected in the computer 1 is available.

The tape width obtaining module 61g receives the information that is related to the tape width of the tape contained in the tape-containing cassette 30 from the tape width informing module 61u in the tape width obtaining process described later. The tape width judging module 61h judges whether or not the width of the tape that the tape width obtaining module 61g received is different from the tape width at the present time (the tape width before display changing process described later is performed). The tape width setting module (for the tape-width-obtaining-mode) 61i sets the tape width to be displayed on the editor screen to the tape width that the tape width obtaining module 61g received.

The tape width setting module 61j (for the tape-width-not-obtaining-mode) sets the tape width to be displayed on the editor screen to the tape width the user instructed (the tape width that the user selected from the pull down menu displayed when the tape width pull down button 84b is clicked, or the tape width set when the user dragged the bottom region 88d of the label view 88). Further, the tape width setting module 61j judges based on the dragging amount by the user which of the pre-decided tape widths (such as 6 mm, 9 mm, 12 mm, 18 mm, 24 mm, and 36 mm) is the nearest to the tape width the user instructed and that the nearest tape width is the one the user instructed.

The tape length setting mode judging module 61k judges whether the tape length auto setting button 85 is pushed (the state of FIG. 5D: the tape length auto setting mode) or is not pushed (the state of FIG. 5A, FIG. 5B, and FIG. 5C: the tape length manual setting mode) from the result analyzed by the input information analyzing module 61a. In the tape auto setting mode, the tape length setting module 61l sets the tape length to be displayed on the editor screen to the tape length decided based on the length of the longest line of the text. In the tape length manual setting mode, the tape length setting module 61l sets the tape width to be displayed on the editor screen to the tape width the user instructed.

The text judging module 61m judges whether or not the user input text during text editing, from the text data to be displayed that is stored in the RAM 64. The point size setting module 61n sets the point size of the text 88b in the label view 88, based on the tape width set by the tape width setting module 61i or the tape width setting module 61j.

The display data generating module 61o generates the display data to be displayed for the label view in the text display area 91, based on the tape width set by the tape width setting module 61i or the tape width setting module 61j, and on the point size set by the point size setting module 61n, making use of the data stored in the CG-ROM 62, and generates the display data for tape width to be displayed in the tape size display area 89 based on the tape width set by the tape width setting module 61i or the tape width setting module 61j. Further, the display data generating module 61o generates the display data for tape length to be displayed in the tape size display area 89, based on the tape length set by the tape length setting module 61l.

The display controlling module 61p controls to display the editor screen as shown in FIG. 5A to FIG. 5B on the LCD 5, and displays the above-described label view 88 in the text display area 91 and the tape width of the printing tape in the tape size display area 89, based on the display data generated by the display data generating module 61o. Further, the display controlling module 61p controls the other controls such as to display the tape length in the tape size display area 89.

The tape width obtaining module 61q receives the information related to the tape width of the tape contained in the tape-containing cassette 30 installed in the printing device 2. The tape width obtaining judging module 61r judges whether or not the tape width obtaining module 61q received the information related to the tape width from the printing device 2. The tape width renewing module 61s renews the tape width stored in the RAM 64 to the tape width received by the tape width obtaining module 61q.

The timer process judging module 61t judges whether or not the process being performed by the CPU 61 is the first timer process. The tape width informing module 61u informs the above-described tape width obtaining module 61g of the information related to the tape width stored in the RAM 64.

<<Mode Setting Process>>

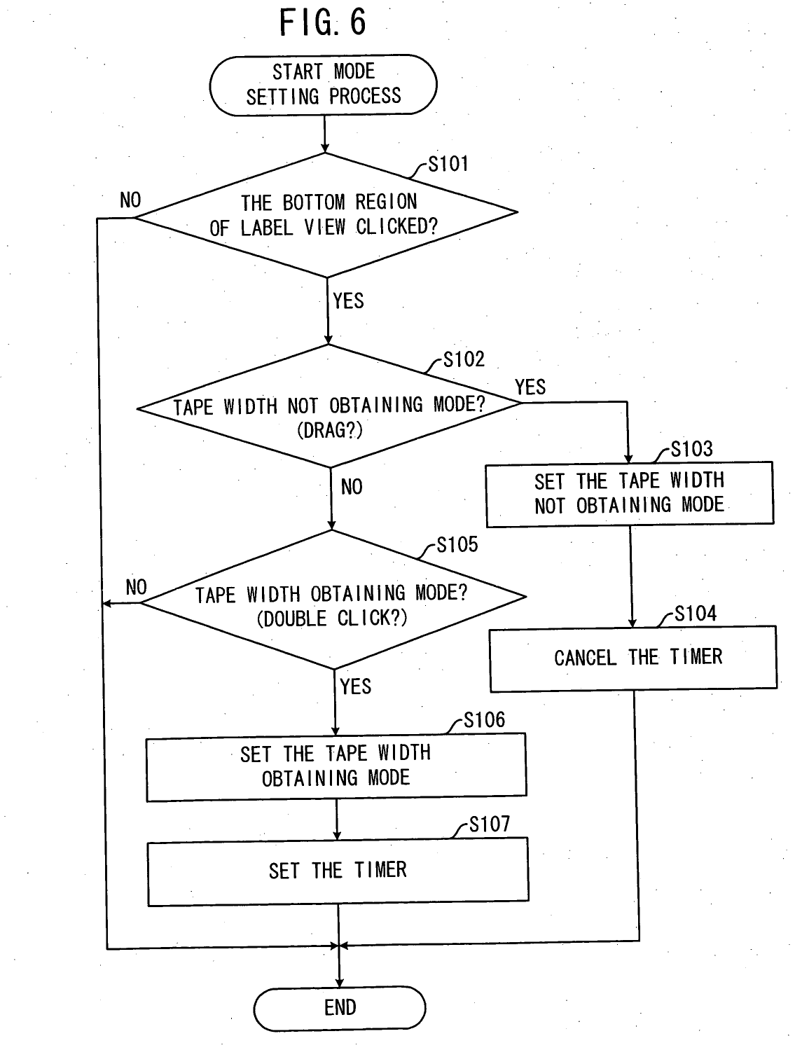

The mode setting process to be performed by the CPU 61 of the computer 1 will be described referring to FIG. 6. FIG. 6 is a flowchart that shows operations of the mode setting process performed by the CPU. The flowchart is for the case that either the tape-width-obtaining-mode or the tape-width-not-obtaining-mode is set, making use of the lower part of the label view. Further, the user can set the mode before, during and after editing the text. The mode setting processes in those cases are the same.

In step S101, the input information analyzing module 61a of the CPU 61 analyzes whether or not the bottom region 88d of the label view 88 displayed in the text display area 91 was clicked, according to the coordinate signal input through the I/F 66 from the mouse 7. According to this analyzed result, the mode judging module 61b judges whether or not the user operated to set or switch the mode (the tape-width-obtaining-mode, or the tape-width-not-obtaining-mode). If the mode judging module 61b judged that the bottom region 88d of the label view 88 was clicked by the user (the mode was set or switched by the user) (“Yes” in step S101), the control proceeds to step S102. On the other hand, if the mode judging module 61b judged that the bottom region 88d of the label view 88 was not clicked by the user (“No” in step S101), it judges that neither operations of setting mode nor switching mode is operated and the mode setting process is finished.

In step S102, the input information analyzing module 61a of the CPU 61 analyzes whether or not the bottom region 88d of the label view 88 displayed in the text display area 91 was dragged, according to the coordinate signal input by the mouse 7. According to this analyzed result, the mode judging module 61b judges whether or not the user designated the tape-width-obtaining-mode. If the mode judging module 61b judged that the tape-width-not-obtaining-mode was designated by the user (“Yes” in step S102), the control proceeds to step S103. On the other hand, if the mode judging module 61b judged that the tape-width-not-obtaining-mode was not designated (“No” in step S102), the control proceeds to step S105.

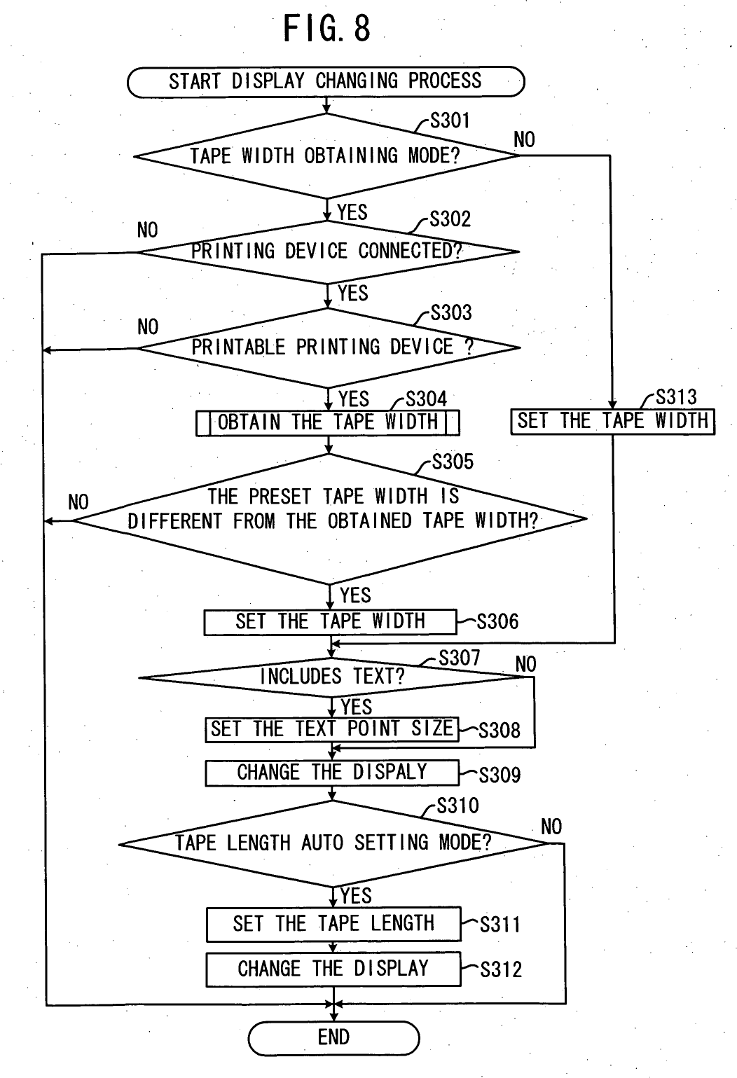

In step S103, where the user had designated the tape-width-not-obtaining-mode, the mode setting module 61c sets the process mode to be performed next by the CPU 61 to the tape-width-not-obtaining-mode. In step S104, the timer setting module 61d cancels the timer 65 because it is not necessary to obtain the tape width of the tape contained in the tape-containing cassette 30. After that, the display changing process to be described later referring to FIG. 8 will be performed.

In step S105, the input information analyzing module 61a of the CPU 61 analyzes whether or not the bottom region 88d of the label view 88 displayed in the text display area 91 was double-clicked, according to the coordinate signal input by the mouse 7. According to this analyzed result, the mode judging module 61b judges whether or not the user designated the tape-width-obtaining-mode. If the mode judging module 61b judged that the tape-width-obtaining-mode was designated by the user (“Yes” in step S105), the control proceeds to step S106. On the other hand, if the mode judging module 61b judged that the tape-width-obtaining-mode was not designated (“No” in step S105), it judges that neither operations of setting mode nor switching mode is operated and the mode setting process is finished.

In step S106 the user had designated the tape-width-obtaining-mode, the mode setting module 61c sets the process mode ahead to be performed by the CPU 61 to the tape-width-obtaining-mode.

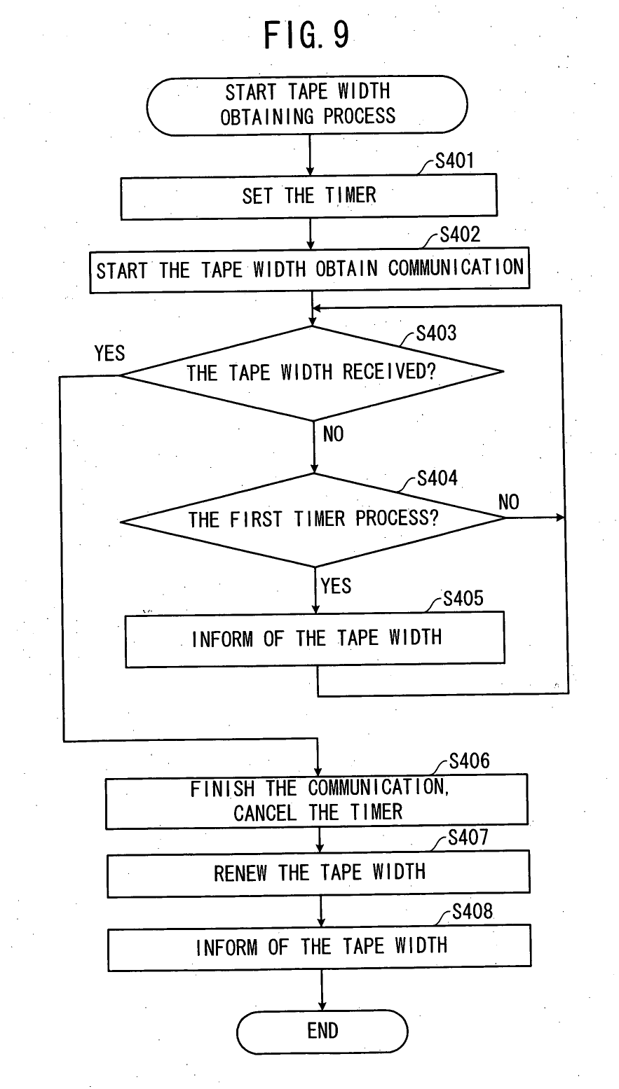

In step S107, the timer setting module 61d sets the timer 65 in order to obtain the tape width of the tape contained in the tape-containing cassette 30. After that, the display changing process to be described later referring to FIG. 8 and the tape width obtaining process to be described later referring to FIG. 9 will be performed.

The above-described process may set the mode to be performed next by the CPU 61 to either the tape-width-obtaining-mode or the tape-width-not-obtaining-mode, and switch from the tape-width-obtaining-mode to the tape-width-not-obtaining-mode or switch from the tape-width-not-obtaining-mode to the tape-width-obtaining-mode.

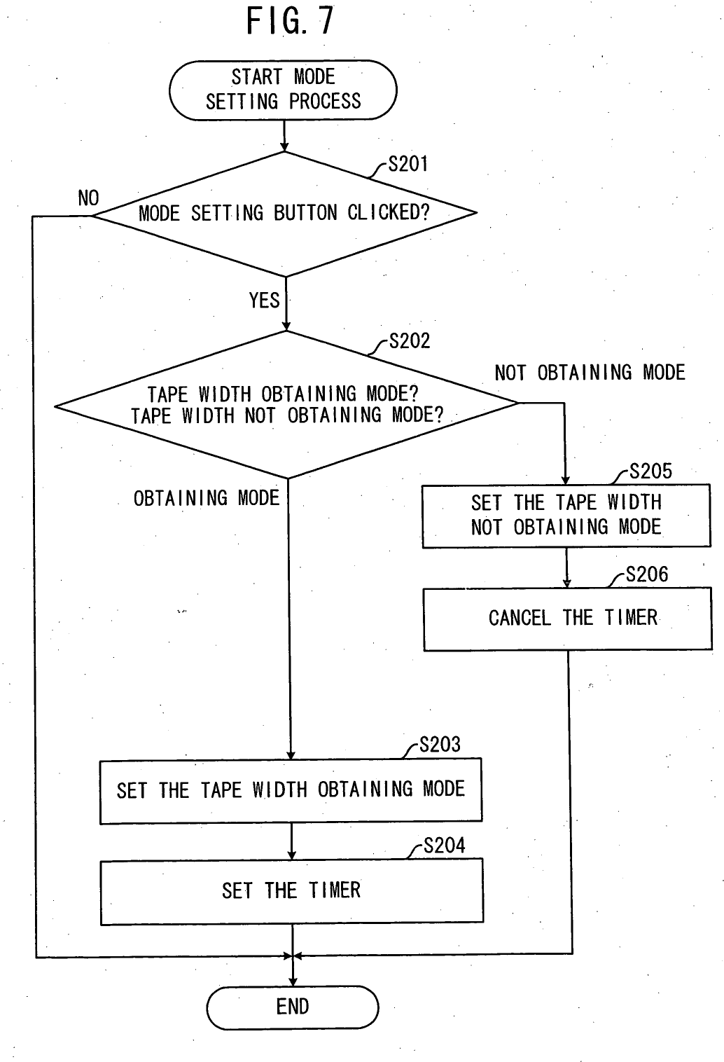

The mode setting process to be performed by CPU 61 in the case that the user uses the mode setting button 87 will be described referring to FIG. 7. FIG. 7 is a flowchart that shows operations of the mode setting module performed by the CPU.

In step S201, the input information analyzing module 61a of the CPU 61 analyzes whether or not the mode setting button 87 was clicked, according to the coordinate signal input through the I/F 66 from the mouse 7. According to this analyzed result, the mode judging module 61b judges whether or not that the user operated to set or switch the mode (the tape-width-obtaining-mode or the tape-width-not-obtaining-mode). When the mode judging module 61b judged that the mode setting button 87 was clicked by the user (the mode was set or switched by the user) (“Yes” in step S201), the control proceeds to step S202. On the other hand, when the mode judging module 61b judged that the mode setting button 87 was not clicked by the user (“No” in step S201), it judges that neither operations of setting mode nor switching mode is operated and the mode setting process is finished.

In step S202, the information analyzing module 61a further analyzes whether the mode setting button 87 was pushed (the condition as shown in FIGS. 5C and 5D: the tape-width-obtaining-mode) or was not pushed (the condition as shown in FIGS. 5A and 5B: the tape-width-not-obtaining-mode). According to this analyzed result, the mode judging module 61b judges whether or not the subsequent process mode in which the CPU 61 is to perform is the tape-width-obtaining-mode or the tape-width-not-obtaining-mode. When the mode judging module 61b judged that the mode is the tape width-obtaining-mode (“obtaining mode” in step S202), the control proceeds to step S203. When the mode judging module 61b judged that the mode is the tape-width-not-obtaining-mode (“not obtaining mode” in step S202), the control proceeds to step S205.

In step S203 and S204, the processes of step S106 and S107 described in FIG. 6 are performed respectively. The mode setting module 61c sets the tape-width-obtaining-mode (in step S203), and the timer setting module 61d sets the timer (in step S204).

In step S205 and S206, the processes of step S103 and S104 described in FIG. 6 are performed respectively. The mode setting module 61c sets the tape-width-not-obtaining-mode (in step S205), the timer canceling module 61e cancels the timer (in step S206).

Similarly to FIG. 6, the above-described processes may set the subsequent mode in which the CPU 61 is to perform either the tape-width-obtaining-mode or the tape-width-not-obtaining-mode, and switch from the tape-width-obtaining-mode to the tape-width-not-obtaining-mode or switch from the tape-width-not-obtaining-mode to the tape-width-obtaining-mode.

<<Display Changing Process>>

The display changing process to be performed by the CPU 61 will be described referring to FIG. 8. FIG. 8 is a flowchart that shows operations of the display changing module to be performed by the CPU.

In step S301, the mode judging module 61b judges whether or not the process mode to be performed next by the CPU 61 is the tape-width-obtaining-mode. When the mode judging module 61b judged the mode is the tape-width-obtaining-mode (the tape-width-obtaining-mode was set by the mode setting module 61c) (“Yes” in step S301), the control proceeds to step S302. On the other hand, when the mode judging module 61b judged the mode is not the tape-width-obtaining-mode (the tape-width-not-obtaining-mode was set by the mode setting module 61c) (“No” in step S301), the control proceeds to step S313.

In step S302, the printer recognizing module 61f judges whether or not the printing device 2 is connected to the computer 1. When the printer recognizing module 61f judged that the printing device 2 is connected to the computer 1 (“Yes” in step S302), the control proceeds to step S303. On the other hand, when the printer recognizing module 61f judged that the printing device 2 is not connected to the computer 1 (“No” in step S302), the display changing process is finished.

In step S303, the printer recognizing module 61f judges whether or not a printer driver for controlling the printing device 2 connected to the computer 1 is installed in the computer 1 (whether or not the printing device 2 connected to the computer 1 is available). When the printer recognizing module 61f judged that the printing device 2 is available (“Yes” in step S303), the control proceeds to step S304. On the other hand, when the printer recognizing module 61f judged that the printing device 2 is not available (“No” in step S303), the display changing process is finished.

In step S304, the tape width obtaining module 61g receives the information that is related to the tape width of the tape contained in the tape-containing cassette 30 from the tape width informing module 61u in the tape width obtaining process described later.

In step S305, the tape width judging module 61h judges whether or not the width of the tape that the tape width obtaining module 61g received in step S304 is different from the tape width at the present time (the tape width before the display changing process is performed). When the tape width judging module 61h judged that the tape width is different (“Yes” in step S305), the control proceeds to step S306. On the other hand, when the tape width judging module 61h judged that the tape widths are not different (“No” in step S305), the display changing process is finished because there is no need to change the display content of the editor screen.

In step S306, the tape width setting module 61i sets the tape width to be displayed on the editor screen to the tape width the tape width obtaining module 61g received in step S304.

In step S307, the text judging module 61m judges whether or not the user input text during text editing, from the text data to be displayed that is stored in the RAM 64. If the text judging module 61m judged that the user input the text (“Yes” in step S307), the control proceeds to step S308. On the other hand, if the text judging module 61m judged that the user did not input the text (“No” in step S307), the control proceeds to step S309.

In step S308, the point size setting module 61n sets the point size of the text 88b in the label view 88, according to the tape width set by the tape width setting module 61i or the tape width setting module 61j. FIG. 5E shows the label view 88 displayed in the text display area 91 when the tape width is 12 mm, and FIG. 5F shows the label view 88 displayed in the text display area 91 when the tape width is 12 mm. If the tape width judging module 61h judged that the tape width that the tape width obtaining module 61g received in step S304 is narrower than the tape width at the present time (the tape width before the display changing process is performed), as shown FIG. 5E to FIG. 5F, the point size setting module sets a reduction of the point size of the text 88b (“Hello!”) in the label view 88. Conversely, if the tape width judging module 61h judged that the tape width that the tape width obtaining module 61g received in step S304 is wider than the tape width at the present time (the tape width before the display changing process is performed), as shown FIG. 5F to FIG. 5E, the point size setting module sets a magnification of the point size of the text 88b (“Hello!”) in the label view 88.

In step S309, according to the tape width set in step S306 or S313, the display data generating module 61o generates the display data for the label view, and further generates the display data for tape width to be displayed on the tape size display area 89. In addition, the display controlling module 61p changes the display of the editor screen, according to the display data generated by the display data generating module 61o.

With this change, in the tape-width-not-obtaining-mode, the width of the tape image 88a of the label view 88 to be displayed in text display area 91 changes to correspond to the width the user instructed, and in the tape-width-obtaining-mode, changes to correspond to the tape width of the tape contained in the tape containing cassette 30. In addition, the text 88b of the label view 88 changes the point size to correspond to the point size set by the point size setting module 61h. Further, in the tape-width-not-obtaining-mode, the tape width of the tape to be displayed in the tape size display area 89 changes to the tape width instructed by the user, and in the tape-width-obtaining-mode, changes to the tape width of the tape contained in the tape-containing cassette 30.

For instance, in the tape-width-not-obtaining-mode, if the tape width instructed by the user is 18 mm, the display content is changed from FIG. 5A to FIG. 5B. Also, in the tape-width-obtaining-mode, if the tape width of the tape contained in the tape-containing cassette 30 was informed of 12 mm, the display content is switched from FIG. 5A to FIG. 5C.

In step S310, the input information analyzing module 61a analyzes whether the tape length auto setting button 85 was pushed (the state shown in FIG. 5D: the tape length auto setting mode) or was not pushed (the condition as shown in FIG. 5A, FIG. 5B and FIG. 5C: the tape length manual setting mode). According to this analyzed result, the tape length setting mode judging module 61k judges whether the process mode to be performed by the CPU 61 next is the tape length auto setting mode or the tape length manual setting mode. If the tape length setting mode judging module 61k judged the mode is the tape length auto setting mode (“Yes” in step 310), the control proceeds to step S311. On the other hand, if the tape length setting mode judging module 61k judged the mode is the tape length manual setting mode (“No” in step S310), the display changing process is finished because there is no need to change the display content further.

In step S311, the tape length setting module 61l sets the tape length, according to the longest line of the text.

In step S312, the display data generating module 61o generates the display data for label view according to the tape length set in step S311, and further generates the display data for tape length to be displayed in the tape size display area 89. In addition, the display controlling module 61p changes the display of the editor screen, according to the display data generated by the display data generating module 61o.

With this change, the tape length of tape image 88a in the label view 88 to be displayed in the text display area 91 changes to correspond to the length that fits the longest line of text the user edited. The length is displayed in the tape size display area 89 as tape length. For instance, when the tape length set by the tape length setting module 61l is 64 mm, the display content is changed from FIG. 5C to FIG. 5D.

In step S313, the tape width setting module 61j sets the tape width to be displayed on the editor screen to the tape width the user instructed (the tape width that the user selected from pull down menu displayed when the tape width pull down button 84b is clicked or the tape width that the user dragged the bottom region 88d of the label view 88). In addition, the control proceeds to the above-described step S307.

As described above, in the tape-width-obtaining-mode, the width of the tape image 88a of label view 88 changes to correspond to the width corresponding to the tape width of the present tape contained in the tape containing cassette 30, and further the tape width to be displayed in the tape size display area 89 changes to correspond to the tape width of the tape contained in the tape containing cassette 30. In addition, in tape-width-not-obtaining-mode, the width of tape image 88a in label view 88 changes to correspond to the width corresponding to the width the user designated, and further the tape width of the tape to be displayed in the tape size display area 89 changes to correspond to the tape width instructed by the user.

Therefore, in the tape-width-obtaining-mode, the user can grasp the information related to the tape width of the tape loaded in the printing device, and can edit the text while grasping the tape width. As a result, the user will not edit text for a tape having a tape width that is not loaded in the printing device.

In tape-width-not-obtaining-mode, regardless of the tape width of the present tape contained in the printing device, the user can edit the text with any tape width the user instructed. As a result, for instance, even if a tape having the desired tape width is not installed in the printing device 2, the user can edit the text in advance, then place a tape with desired tape width into the printing device 2, and print the edited text by the printing device 2.

Also, the user can change into the tape-width-obtaining-mode after editing the text in the tape-width-not-obtaining-mode, so that the user will have great flexibility to edit text. Further, the user can grasp the tape width of the tape installed in the printing device 2 both in numerical value and in visual tape image.

<<Tape Width Obtaining Process>>

The tape width obtaining process to be performed by the CPU 61 of computer 1 will be described referring to FIG. 9. FIG. 9 is a flowchart showing operations of the tape-width-obtaining-mode to be performed by the CPU.

In step S401, the timer setting module 61d sets the timer 65 to generate signals at fixed time intervals (such as one second).

In step S402, the CPU 61 starts communicating with the printing device 2 in order to obtain the tape width of the tape contained in the tape-containing cassette 30 installed in the printing device 2.

In step S403, the tape width obtaining judging module 61r judges whether or not the tape width obtaining module 61q received the information related to the tape width from the printing device 2. If the tape width obtain judging module 61r judged that the tape width obtaining module 61q received the tape width (“Yes” in step S403), the control proceeds to step S406. On the other hand, if the tape width obtain judging module 61r judged that the tape width obtaining module 61q does not receive the tape width (“No” in step S403), the control proceeds to step S404.

In step S404, the timer process judging module 61t judges whether or not the process being performed by the CPU 61 is the first timer process. If the timer process judging module 61t judged that it was the first timer process (“Yes” in step S404), the control proceeds to step S405. On the other hand, if the timer process judging module 61t has not judged that it was the first timer process (“No” in step S404), the control returns to step S403.

In step S405, the tape width informing module 61u informs the above-described tape width obtaining module 61g of the information related to the tape width stored in the RAM 64. In step S406, the CPU 61 finishes communication with the printing device 2, and the timer canceling module 61e cancels timer 65.

In step S407, the tape width renewing module 61s renews the tape width stored in the RAM 64 to the tape width that the tape width obtaining module 61q received in step S403. Then, in step S408, if the tape width informing module 61u did not inform of the tape width in step S405, the information related to the tape width stored in the RAM 64 is informed to the tape width obtaining module 61g. Even in the case that the tape width is informed in step S405, the information stored in the RAM 64 is renewed in step S407 so as it may be used as the latest information related to the tape width in the next tape width obtaining process.

With the above-described process, if the tape width obtaining module 61q could obtain the information related to the tape width of the tape installed in the printing device 2 from the printing device 2 before the first timer process, that tape width is used in the display changing process (FIG. 8). On the other hand, if the tape width obtaining module 61q could not obtain the information, the tape width stored in the RAM 64 before starting the tape width obtaining process (the tape width of the last time) is used in the display changing process (FIG. 8). Therefore, it is more possible that the tape width to be used in the display changing process is in accordance with the tape width of the tape contained in the tape-containing cassette 30, so that usability for users is superior.

While the invention has been described in detail with reference to a specific embodiment thereof, it will be apparent to those skilled in the art that various changes and modifications may be made therein without departing from the spirit of the invention. For example, in the above-described embodiment, the computer 1 and the printing device 2 are connected with each other via the connecting cable 3. However, it is possible to apply the above-described function to a stand-alone machine. Also, the above-described embodiment has been described for printing the text edited by the user on tape. However, it is possible to make stamps, or to engrave the text on a sealing medium as an image forming medium.

Also, the program that causes the CPU to perform the processes shown in the flowcharts of FIG. 6, FIG. 7, FIG. 8, and FIG. 9 may be saved in a recording medium such as CD-ROM. In this case, it is easy to sell programs of the above-described processes.

A text editing apparatus of the present invention comprises mode setting means based on inputting information from a user interface, for setting either a medium-information-obtain-mode, in which the information related to the image forming medium to be used is obtained, or a medium-information-not-obtain-mode, in which the information related to the image forming medium to be used is not obtained, mode judging means for judging whether the mode set by the mode setting means is the medium-information-obtain-mode or the medium-information-not-obtain-mode, and instructing means for instructing the information related to the image forming medium, based on the input information from the user interface. If the mode judging means judges that the mode set by the mode setting means is the medium-information-obtain-mode, the display controlling means displays on a display the information related to the image forming medium obtained by the medium information obtaining means, and if the mode judging means judges that the mode set by the mode setting means is the medium-information-not-obtain-mode, the display controlling means displays on the display the information related to the image forming medium obtained by the setting means.

According to the present invention, in the medium-information-obtain-mode, for example, it is possible to edit text while grasping the information related to the image forming medium loaded in the printing device at present. On the other hand, in the medium-information-not-obtain-mode, for example, regardless of the present image forming medium loaded in the printing device, it is possible to edit text on the image forming medium instructed by the user. Those two modes provide more convenience to text editing.

In the text editing apparatus of the present invention, the display controlling means controls to display the latest information related to the image forming medium in a medium information storage means in which the medium information is stored in the event that the mode judging means judges that the mode set by the mode setting means is the medium-information-obtaining-mode and that the medium information obtaining means can not obtain the information related to the image forming medium.

With the present invention, even if it failed to obtain the information related to the image forming medium, the latest successfully obtained information related to the image forming medium is displayed on the display. Therefore, it is likely that the information related to the image forming medium displayed on the display is the information related to the image forming medium that is actually used, so that it is possible and more convenient to edit text based on the information.

The text editing apparatus of the present invention may further include a mode switching means for switching from the medium-information-not-obtain-mode to the medium-information-obtain-mode, based on the input information from the user interface. When the medium-information-not-obtain-mode is switched to the medium-information-obtain-mode by the mode switching means, the display controlling means switches the information to be displayed on the display from the information related to the image forming medium instructed by the instructing means to the information related to the image forming medium obtained by the medium information obtaining means.

With the present invention, it is possible to switch from the medium-information-not-obtain-mode to the medium-information-obtain-mode during and after text editing, so that usability for setting mode is superior.

In the text editing apparatus of the present invention, the information related to the image forming medium may be the information of the width of the image forming medium, and the display controlling means displays on the display the numerical value which indicates the width of the image forming medium.

With the present invention, the tape width of the tape, which is one type of the image forming medium, is displayed on display in numerical value, so that the user can easily grasp the tape width of the tape to be used.

In the text editing apparatus of the present invention, the information related to the image forming medium is the information of the width of the image forming medium, and the display controlling means displays an image of the image forming medium on the display the width of which corresponds to the width of the image forming medium.

With the present invention, the tape, which is one type of the image forming medium, is displayed on display as an image of the tape having a tape width, so that the user can visually grasp the tape width of the tape to be used.

A program to attain above-described functions can be distributed in removable recording media such as CD-ROM or stationary recording media such as hard disc, and can be further distributed through communication network such as internet by wired or wireless electric communication means.

In the medium-information-obtain-mode, for example, it is possible to edit text while grasping the information related to the image forming medium currently loaded in the printing device. On the other hand, in the medium-information-not-obtain-mode, for example, regardless of the image forming medium currently loaded in the printing device, it is possible to edit text on the image forming medium instructed by the user. Those two modes provide more convenience to text editing.

With the present invention, even if it failed to obtain the information related to the image forming medium, the latest successfully obtained information related to the image forming medium is displayed on display. Therefore, it is likely that the information related to the image forming medium displayed on the display is the information related to the image forming medium to be actually used, so that it is possible and more convenient to edit text based on the information.

With the present invention, it is possible to switch from the medium-information-not-obtain-mode to the medium-information-obtain-mode during and after text editing, so that usability for setting mode is superior.

With the present invention, the tape width of the tape, which is one type of the image forming medium, is displayed on display in numerical value, so that the user can easily grasp the tape width of the tape to be used.

With the present invention, the tape, which is one type of the image forming medium, is displayed on display as an image of the tape having a tape width, so that the user can visually grasp the tape width of the tape to be used.

Industrial Applicability

As described above, with the present invention, the information related to the image forming medium to be used for forming text is displayed on display so that user can grasp the information related to the image forming medium to be used for forming the text. By grasping the information related to the image forming medium to be used, the user can edit the text. Therefore, usability is superior when editing text.

1. A text editing apparatus for editing text to be formed on an image forming medium, comprising:
medium information obtaining means for intermittently obtaining information related to the image forming medium to be used; and
display controlling means for controlling to display on a display the information related to the image forming medium obtained by the medium information obtaining means.

2. The text editing apparatus according to claim 1, further comprising:
mode setting means for setting, based on information input from a user interface, either a medium-information-obtain-mode in which the information related to the image forming medium to be used is obtained or a medium-information-not-obtain-mode in which the information related to the image forming medium to be used is not obtained;
mode judging means for judging whether the mode set by the mode setting means is the medium-information-obtain-mode or the medium-information-not-obtain-mode; and
instructing means for providing the information related to the image forming medium, based on the information input from the user interface;
wherein the display controlling means displays on the display the information related to the image forming medium obtained by the medium information obtaining means, when the mode judging means judges that the mode set by the mode setting means is the medium-information-obtain-mode; and
the display controlling means displays on the display the information related to the image forming medium provided by the instructing means, when the mode judging means judges that the mode set by the mode setting means is the medium-information-not-obtain-mode.

3. The text editing apparatus according to claim 2, wherein the display controlling means controls to display a most recent information related to the image forming medium in medium information storage means in which the information related to the image forming medium is stored in the event that the mode judging means judges that the mode set by the mode setting means is the medium-information-obtaining-mode, and that the medium information obtaining means can not obtain the information related to the image forming medium.

4. The text editing apparatus according to claim 2, further comprising mode switching means for switching from the medium-information-not-obtain-mode to the medium-information-obtain-mode, based on the input information from the user interface,
wherein the display controlling means switches information to be displayed on the display from the information related to the image forming medium provided by the instructing means to the information related to the image forming medium obtained by the medium information obtaining means when the medium-information-not-obtain-mode is switched to the medium-information-obtain-mode by the mode switching means.

5. The text editing apparatus according to claim 1, wherein the information related to the image forming medium is information of a width of the image forming medium; and the display controlling means displays numerical value on the display which indicates the width of the image forming medium.

6. The text editing apparatus according to claim 1, wherein the information related to the image forming medium is information of a width of the image forming medium; and the display controlling means displays an image of the image forming medium on the display, a width of which corresponds to the width of the image forming medium.

7-18. (Canceled)

19. A computer-readable program for causing a computer to edit text to be formed on an image forming medium, the program including instructions that cause the computer to:
intermittently obtain information related to the image forming medium; and
control a display so as to display the intermittently obtained information related to the image forming medium.

20. The program according to claim 19, further including instructions that cause the computer to:
enable the setting of either a medium-information-obtain-mode in which the information related to the image forming medium is obtained, or a medium-information-not-obtain-mode in which the information related to the image forming medium is not obtained;
judge whether the set mode is the medium-information-obtain-mode or the medium-information-not-obtain-mode; and
receive the information related to the image forming medium from a user interface,
wherein the display is controlled to display the intermittently obtained information related to the image forming medium when it is judged that the set mode is the medium-information-obtain-mode; and
the display is controlled to display the information related to the image forming medium provided by the user interface when it is judged that the set mode is the medium-information-not-obtain-mode.

21. The program according to claim 20, wherein the display is controlled to display a most recent information related to the image forming medium in a medium information memory in which the information related to the image forming medium is stored when it is judged that the set mode is the medium-information-obtaining-mode, and that it is not possible to obtain the information related to the image forming medium.

22. The program according to claim 20, further including instructions that cause the computer to:
switch from the medium-information-not-obtain-mode to the medium-information-obtain-mode, based on the information input from the user interface,
wherein the display is controlled to switch the displayed information from the information related to the image forming medium provided by the user interface to the intermittently obtained information related to the image forming medium, when the mode-information-not-obtain-mode is switched to the mode-information-obtain-mode.

23. The program according to claim 19, wherein the information related to the image forming medium is information of a width of the image forming medium; and the display is controlled to display a numerical value which indicates the width of the image forming medium.

24. The program according to claim 19, wherein the information related to the image forming medium is information of a width of the image forming medium; and the display is controlled to display an image of the image forming medium, the image having a width corresponding to the width of the image forming medium.

25. A text editing apparatus for editing text to be formed on a recording medium, the apparatus comprising:
a medium information sensor that obtains information related to the recording medium that is to be used with the text editing apparatus;
an operator information input device that enables an operator to input the information related to the recording medium;
a mode selector that selectively sets a first mode to obtain the information related to the recording medium from the medium information sensor, and a second mode not to obtain the information related to the recording medium from the medium information sensor; and
a display controller that causes the display of the information related to the recording medium obtained by the medium information sensor when the first mode is set, and causes the display of the information related to the recording medium provided by the operator information input device when the second mode is set.

26. A tape printing apparatus that can accommodate tape cassettes containing tapes of different tape widths, the tape printing apparatus comprising:
an input device that inputs text;
a controller that causes the display of the input text according to a display tape width;
a tape width instructing device that instructs and sets a first tape width as the display tape width;
a tape width sensor that detects and sets a second tape width as the display tape width;
a mode selector that selectively sets either a tape-width-select-mode, in which the display tape width is instructed by the tape width instructing device, or a tape-width-detect-mode, in which the display tape width is instructed by the tape width sensor;
wherein the controller changes a size of the display tape width based on the mode set by the mode selector.

27. The tape printing apparatus according to claim 26, wherein:
the controller compares a tape width of a most recently loaded tape before changing the tape width instructed by the tape width instructing device; and
the controller decreases the size of the display tape width when it is judged that the tape width instructed by the tape width instructing device is narrower than the tape width of the most recently loaded tape.

28. The tape printing apparatus according to claim 26, wherein:
the controller compares a tape width of a most recently loaded tape before changing the tape width instructed by the tape width instructing device; and
the controller increases the size of the display tape width when it is judged that the tape width instructed by the tape width instructing device is wider than the tape width of the most recently loaded tape.

29. The tape printing apparatus according to claim 27, wherein the controller causes the display of a preview image of the text to be printed on the tape, and a size of the text in the preview image is decreased when the size of the display tape width is decreased by the controller.

30. The tape printing apparatus according to claim 26, wherein the controller changes the display tape width for all input text.
